(19) United States
(12) Patent Application Publication
(10) Pub. No.: US 2003/0080193 A1
(43) Pub. Date: May 1, 2003

(54) Portable authentication fluorescence scanner employing single and multiple illumination sources

(76) Inventors: William J. Ryan, Jericho, VT (US); Louis H. Liang, Los Altos, CA (US)

Correspondence Address: THEODORE R TOUW, T.R. TOUW PATENTS, 1874 NW LAURA VISTA DRIVE, ALBANY, OR, 97321, US

(21) Appl. No.: 09/999,855

(22) Filed: Oct. 31, 2001

(51) Int. Cl. G06K 19/06

(52) U.S. Cl. 235/491

(57) ABSTRACT

A portable fluorescence scanner has single or multiple excitation sources at various non-visible wavelengths. If multiple non-visible sources are used, they are disposed in alignment with a selector controllable to select any of the sources. The selected beam illuminates a target article which, if authentic, has been marked with certain fluorescent material(s), and fluorescent light returns, along an optical path that may include a beam splitter, to a photodetector whose signal is processed and analyzed by a digital signal processor (DSP). The DSP also either controls the deflector or receives a signal from a transducer indicating the deflector's orientation, or both. The invention may be configured as a hand-held fluorescence scanner. Multiple UV laser diode or UV LED sources can be arranged in an array, which may be linear. Multiple photodetectors may be arranged in an array, with a correspondence between individual UV sources and photodetectors, each corresponding pair satisfying a predetermined angular limitation. The scanner may also have one or more visible light sources, used for aiming at indicia to be scanned and/or for optimizing distance from the scanned article.

### FIELD OF THE INVENTION

This invention relates generally to scanners for authenticating articles and, more particularly, to a portable scanner employing single or multiple illumination sources, which may also employ multiple detectors suitably disposed.

### BACKGROUND OF THE INVENTION

The use of fluorescent indicia for authentication of various articles, including currency, passports, etc. is known, as are various forms of apparatus for detecting the presence of such fluorescent indicia on articles.

### NOTATIONS AND NOMENCLATURE

The term “scanner” is used in this specification and the appended claims in a broad sense to include apparatus for the detection of indicia on articles, whether or not any beam is deflected or “scanned” in that apparatus.

### DESCRIPTION OF RELATED ART

U.S. Pat. No. 3,207,910 to Hirschfeld et al. discloses an arrangement by which fluorescent markings on articles which themselves are fluorescent may be scanned for identifying and/or sorting the articles. That invention provides means for separating two mutually exclusive bands of wavelengths from the wavelengths which emanate from a portion of the scanned articles due to excitation of that portion.

U.S. Pat. No. 3,473,027 to Freeman et al. discloses a process of recording information and retrieving it, which process comprises forming symbols of inks having one or more photoluminescent components which luminesce under ultraviolet or other short wave illumination in at least one wavelength band different from that of any other luminescent component. The code consists in the presence in one or more concentrations or the absence of the photoluminescent components.

U.S. Pat. No. 3,621,250 to Wetzstein describes coded inks having one or more photoluminescent components to represent different symbols which can then be read out by ultraviolet illumination. For example, six components can represent 63 different symbols by their presence or absence in a mark. A set of components is divided into two groups, for example, four and two, in the case of six components. The four components are sufficient to generate 15 different symbols, for example, more than enough to represent 10 digits. These symbols are printed in four spatially separated small marking areas, which may be circles or squares. Four digits, if arranged sequentially can represent the numbers 0 to 9,999; however, their sequence has to be known. The other group of components, for example, two, is incorporated into the marks to define the intended sequence of symbols regardless of the actual sequence in which marks are read. This patent discloses a UV reader having a plurality of detectors.

U.S. Pat. No. 4,243,318 to Stöhr discloses fluorescence analysis of multiply stained particles, particularly biological cells, in a continuous flowthrough procedure, in which the particles are suspended in a carrier fluid, the carrier fluid containing the suspended particles is encased in a sheath stream, the resulting composite stream is conducted in laminar flow through an intensive laser light zone where fluorescent light pulses are generated by the action of the laser light on the particles and emanate from the particles, and those fluorescent pulses are detected and processed in real time in an electronic evaluation system. The laser light zone is produced by focussing at least two laser beams of respectively different wavelengths on two points spaced at a given distance apart along the path of the particle-containing fluid in the composite stream. The detection and processing is effected by correlating the fluorescence pulses emanating from the two points on the basis of the spacing between the two points and of the flow speed of the stream, in order to evaluate only those pulses which correspond to the travel time of individual particles between the two points. The two lasers have different wavelengths matched to the dyestuffs or their fluorescence spectra; examples of laser wavelengths are 350 nm and 488 nm.

U.S. Pat. No. 4,578,571 to Williams discloses a compact, portable bar code scanner employing as a light source a light-emitting diode (LED) and consuming extremely low input power. The scanner, which detects the reflectances from bars and spaces of the bar code symbol, uses optical beam-shaping methods to attain a large depth-of-focus for a non-laser system. A shaped illuminating light beam is caused to blink when the symbol is outside the depth-of-focus range and a signature imposed upon the light beam enables the scanner to substantially reject light interference. A scanning version employs an optical assembly mounted upon a bimorph leaf spring that is caused to vibrate at its natural mechanical resonance. The Williams scanner operates with bar code symbols responsive to red light and is of sufficiently low weight to be easily hand-held.

JP 63-184180 (1988) discloses positioning of a scanner using both visible and invisible radiation, the visible radiation indicating the scanning state.

U.S. Pat. Nos. 4,760,248, 4,806,742, and 4,816,660 (all to Swartz et al.) disclose a portable scanner with large focal depth, focusing lens, visible aiming light using an LED, light source in the non-visible range, and a near-IR source for scanning. A portable laser diode scanning head, aimable at each symbol to be read, emits and receives non-readily-visible laser light, and is equipped with a trigger-actuated aiming light arrangement for visually locating and tracking each symbol. A compact laser diode optical train and an optical folded path assembly, as well as an interchangeable component design and an integral window construction for the head also are disclosed.

JP 01-223491 (1989) discloses an inconspicuous-color bar code printed over visible information and read with a UV/IR scanner.

U.S. Pat. No. 4,831,275 to Drucker discloses a scanning device and method for reading bar-code or other contrasting marks from a surface at variable distance from the scanning device operates by modulating the focal point of the optical system. This yields pulse responses on detected code bars while in focus for reading the bar code, and yields average background response levels from the bar-code surface while out of focus.

Modulation of focal point of the optical system is achieved in selected ways such as by positioning optical elements using piezoelectric or electromagnetic drivers or liquid-crystal elements, or by staggering the positions along an optical axis of arrays of optical sensors, or of arrays of optical fibers coupled to the sensors. FIG. 5 shows a tilted detector array.

U.S. Pat. No. 4,908,516 to West discloses the use of a transmittance filter and multiple detectors in apparatus for characterizing or identifying an article having a magnetic material on it which stores information relating to the article, the apparatus comprising means for irradiating the article with electromagnetic radiation of a particular spectral characteristic, means for detecting electromagnetic radiation which is emitted by or reflected from the article due to the irradiation, means for determining whether or not the detected radiation has prescribed spectral characteristics in order to detect whether or not the article is genuine, and a magnetic detector means for reading information which is stored on the magnetic material, the means for detecting being arranged to control the magnetic detector means in response to the detection or whether or not the article is genuine. The invention also provides a method for characterizing or identifying an article having a magnetic material on it which stores information relating to the article.

U.S. Pat. No. 4,983,817 to Dolash et al. discloses the use of field discrimination to eliminate reflected non-luminescent light and discloses the use of a dual light source, for example, an ultraviolet light source and a helium-neon laser. Dolash et al. discloses methods and apparatus for reading a luminescent and substantially transparent bar code on a background surface whose reflectance may vary over the coded area. Light scans and excites luminescence in the bar code. The light also reflects without luminescence from the background surface of the bar code. A first electrical or optical signal is provided responsive to the reflected non-luminescent light, and a second electrical or optical signal is provided responsive to the luminescent light. Typically the first signal is processed to provide a third signal that varies with background reflectance substantially as does the second signal; and the second and third signals are combined to provide a fourth signal that is substantially independent of background reflectance in the coded area, and which is decoded to provide the desired reading.

JP 03-232081 discloses a scanner with an infrared LED, lens, and filter for the infrared light disposed off the centerline of a barcode reader.

JP 3-214280 discloses an optical reading device using an ultraviolet source and a cut-off filter transmitting only wavelengths longer than 450-500 nm.

U.S. Pat. No. 5,107,445 to Jensen, et al. describes a luminescence-based integrated optical and electronic system for measuring temperature or some other parameter from the decay time of a luminescent sensor. The entire optical and electronic portions of the measuring system can be accommodated on a small single circuit card. Similarly, U.S. Pat. No. 5,414,266 to Sun discloses a system for measuring a parameter, such as temperature, including a sensor of that parameter, such as a luminescent material based sensor at an end of an optical fiber, and an electro-optic module connected to the sensor, such as through the optical fiber, in order to measure changes in some sensor characteristic, such as luminescence decay time, that is related to the parameter to which the sensor is being subjected. The electro-optical module is formed substantially entirely on a single printed circuit card, and the module and the sensor optically communicate over an optical fiber medium.

U.S. Pat. No. 5,206,490 to Petigrew et al. discloses a method of bar code printing in which the bar code is printed directly onto packaging material associated with the product. The ink used to produce the bar code is such that indicia constituting the bar code can be discriminated regardless of the background onto which the bar code is printed. Petigrew et al. discloses the use of two or more lasers having outputs in relatively distant parts of the electromagnetic spectrum, e.g., YAG at the blue end and CO2 at the red end.

JP 5-094556 discloses a scanner with single UV source and three detectors for three different wavelengths of fluorescence, e.g. blue, yellow, and red, to increase the information recorded in a fixed area.

U.S. Pat. No. 5,280,333 to Wunderer discloses illumination of fluorescent material using two wavelength sources. In an apparatus for testing documents, the optical illuminating unit comprises at least one light guide provided with fluorescent substance for directing at least two light fractions of different wavelengths onto a common area of the document. The light fractions are switched on and off by the time-division multiplex method. Special switching regulators are provided for regulating not only the switch-on and switch-off operation of the illumination sources but also their brightness.

U.S. Pat. No. 5,290,419 to Kambara et al. discloses excitation of fluorophores for DNA analysis using multiple wavelength sources. In a multi-color fluorescence detection type electrophoresis apparatus provided with an electrophoresis gel plate, excitation laser source, means to separate the fluorescence images according to each emission wavelength, and the detector of the fluorescence subjected to wavelength selection, and two or more laser sources are provided. Each of the laser lights is irradiated on the sample on a time-sharing basis, and the filter which cuts off the scattered light of each the laser synchronous with the laser beam is installed in front of the wavelength separation means. The apparatus provides simultaneous, quick, and real-time analysis of a great number of samples such as DNA and RNA labeled by many types of fluorophores, without overlapping the wavelengths of the excitation light and the fluorescence.

U.S. Pat. No. 5,306,900 to Metlitsky et al. discloses a hand-held bar code scanner with adjustment of direction of an emitted light beam. A bar code symbol scanning system employs a laser, optical and sensor components, and a superstructure mounted on a housing and has a movable exit port to adapt the housing to steer a laser beam through the exit port to a particular course. Both right- and left-handed users are thereby accommodated.

U.S. Pat. No. 5,380,992 to Damen et al. discloses a UV barcode reader performing bar code detection using background-correlated bar criterion for ascertaining the presence of a bar. Detection of a bar code pattern is performed by testing the bar code signal F(t) within each area in which a bar may be expected, against a bar criterion obtained by prediction, with the aid of a prediction table, from a local background signal value locally derived from the bar code signal F(t). In this method, use is made of the fact that, first, between the bars the background of the carrier is invariably present, making a periodical reliable background approximation from the bar code signal value possible, and, second, there is a certain correlation between a background and the additive signal contribution as a response of the bars luminescing from that background under irradiation. The prediction table is compiled beforehand from series of values—obtained with the aid of a test set of letters—for the average background signal, the maximum variation thereof, and the corresponding minimum bar response. The properties of the bar ink used and the pickup means for obtaining the bar code signal are expressed in these values. The advantage is that background influence, notably as a result of the local or global luminescence of the background itself, no longer adversely affects the reliability of a ‘bar/no bar’ decision.

WO97/06502 by Atherton, et al. discloses an optical image authenticator for authenticating images, whereby a light intensity pixel array is detected and compared with a reference pixel array. Authentication is done on the basis of the number of good/bad pixels or their ratio. Detection is accomplished via a CCD sensor. A laser pulses every frame.

U.S. Pat. No. 5,418,855 to Liang, et al. discloses an authentication system for authenticating articles using a multiplicity of discriminating variables to characterize light detected from the articles after predetermined illumination. That authentication system illuminates the articles with light modulated at a frequency of more than about 50 kHz, and secondary fluorescent light returned from the articles is synchronously detected. A programmable microcomputer digitizes the synchronously detected signal and analyzes it to compare the signal with predetermined standard digital signals. The authentication system can include readers of visible bar codes, readers of magnetic stripe codes, or other readers of coded indicia, in addition to a reader of indicia made with fluorescent substances.

U.S. Pat. Nos. 5,666,417 and 5,574,790 to Liang, et al. disclose a multiple-reader system for authentication of articles using a first reader which employs predetermined modulated illuminating light and a multiplicity of discriminating variables, such as wavelengths, amplitudes, and time delays relative to the modulated illuminating light to characterize fluorescent light detected from fluorescent indicia on the articles. Additional readers, which may be readers of fluorescent marks and/or readers of other indicia, are synchronized with the fluorescence reader by timing signals. The outputs provided by individual readers are combined by a computer programmed to produce the authentication result.

U.S. Pat. No. 5,668,363 to Nishida et al. discloses an optical reading apparatus comprising a light-projecting light member for projecting on a surface of the latent image mark, the light having a wavelength to excite a fluorescent substance contained in the latent image mark having desired information; and a light-receiving member for receiving fluorescence emitted from the surface of the latent image mark. A range in which the latent image mark can be read is formed by setting a point at which the optical axis of the light-projecting member and that of the light-receiving member intersect with each other as a reference. An intersection angle between the two optical axes is preferably in the range of from 10° to 40°. This fluorescence reader has a light source to excite fluorescence and a CCD array for the detection of invisible code.

U.S. Pat. No. 6,028,320 to Uhling discloses a detector for use in a printing device having print media with fluorescent marks indicating at least one characteristic of a sheet of print media. The detector includes a source, a sensor, and a bandstop filter. The source generates a first light signal that is directed at the mark on the sheet of print media, the first light signal having a first predetermined wavelength. The sensor is configured to detect a second light signal from the mark on the sheet of print media, the second light signal arising in response to the first light signal and having a second predetermined wavelength. The bandstop filter is positioned between the sensor and the mark on the sheet of print media and is configured to block from the sensor the first predetermined wavelength of the first light signal generated by the source and transmit to the sensor other wavelengths of light, including the second predetermined wavelength of the second light signal.

U.S. Pat. No. 6,204,915 to Persegol, et al. discloses a measuring probe comprising at least one optic fiber and an electronic circuit comprising a securing device for securing the optic fiber in optic connection with signal conversion means. The electronic circuit comprises a removable electrical connector connected to the signal conversion means such as a light-emitting diode and/or photo-detector to supply or receive electronic signals used by a processing circuit.

U.S. Pat. No. 6,264,107 to Thomas, III et al. discloses a latent illuminance discrimination marker system for authenticating articles. An article for a detector or reader has a latent illuminance marker. A light source illuminates the marker and the marker emits illuminance as phosphorescence. A photosensor detects the emitted illuminance, and the decay time is determined. The decay time is checked to provide identification and/or authentication of different types or generations of objects or articles.

Although the many available fluorescence scanners perform their intended functions, they are generally subject to two specific problems: their non-visible excitation light sources draw high current making mobile application impractical because of a need to carry a heavy power source, and they lack a precise and automatic mechanism to determine if the target article is within the focus range of the detector. Since many authentication applications require mobile operation, it is therefore highly desirable to have an automated authentication scanner that is easily focused, has low battery drain, and is capable of operating reliably in a bright ambient light environment.

### SUMMARY OF THE INVENTION

One aspect of the invention is a portable fluorescence scanner with single or multiple excitation sources at different wavelengths, which may be non-visible wavelengths, e.g., 254 nm and 365 nm. Two different sources (with optional condenser lenses) are disposed in alignment with a selector, such as a movable or pivotable mirror, that can be controlled to switch the beam from either source into an optical path that includes a beam splitter. The selected beam hits a target article which, if authentic, has certain fluorescent material(s), often in the form of fluorescent indicia printed on the article. The resultant fluorescent light emitted from those fluorescent materials passes through the beam splitter to a photodiode detector whose signal is processed and analyzed by a digital signal processor (DSP). The DSP also either controls the pivotable switching mirror or receives a signal from a transducer indicating the switching mirror's orientation, or both. Each of the excitation sources can be modulated, with control of frequency, duty cycle, phase, etc. at one or more frequencies which may be chosen to be significantly higher than the mirror deflection frequency. The fluorescent materials used for tagging authentic articles respond differently to the two wavelengths. Another aspect of the invention is a small, hand-held fluorescence scanner configuration, which has at least one ultraviolet (UV) diode laser or UW LED excitation source and at least one photodiode detector. The optical path of the diode laser or UV LED beam strikes the surface of an article being scanned at an angle that is not perpendicular to the surface. The optical path of the fluorescence radiation returning from the surface being scanned is not at the specular angle with the diode laser or UV LED beam path and has an included angle with that beam path of about 10 to 35 degrees, which may be advantageously chosen to be in the range of about 17-26 degrees included angle. Multiple diode lasers or UV LED's can be arranged in an array, which may be a linear array. Multiple photodiode detectors may also be arranged in an array, with a one-to-one correspondence between individual lasers and photodiodes, each corresponding pair satisfying a predetermined angular limitation. The lasers and photodiodes can be interleaved in a single linear array. In another embodiment, there is one UV laser-diode or UV LED excitation source. An array of photodiodes is arranged so that each diode is disposed to satisfy the angular limitation above, but at slightly different angles, and a circuit (e.g. comparator or multiplexer/DSP) selects a preferred signal, e.g., the highest amplitude signal or the signal having the strongest signal/noise ratio. The scanner may also have one or more visible light sources, used for aiming at indicia to be scanned and/or for optimizing the distance of the scanner from the scanned article.

### BRIEF DESCRIPTION OF THE DRAWINGS

FIG. 1 shows a schematic block diagram of a scanner made in accordance with the invention.

FIG. 2 shows a perspective view of a scanner made in accordance with the invention in a handheld configuration.

FIG. 3 shows a side elevation view of a handheld scanner.

FIG. 4 shows a front elevation view of a handheld scanner.

FIG. 5 shows geometric relationships of excitation sources and detectors in a scanner made in accordance with the invention.

FIGS. 6A-6L illustrate a number of images or patterns that may be projected onto an article in accordance with the invention.

### DETAILED DESCRIPTION OF THE PREFERRED EMBODIMENTS

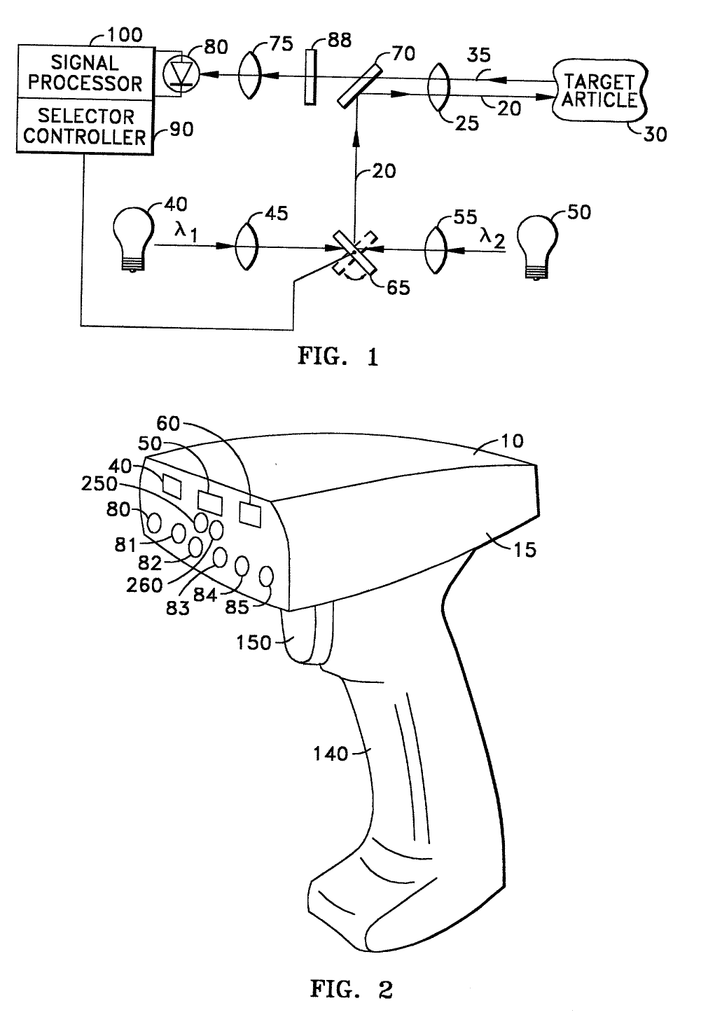

A fluorescence scanner 10 made in accordance with the invention is shown in FIG. 1, and other specific embodiments are illustrated in FIGS. 2-5.

As shown in the drawing, the embodiment of FIG. 1 has multiple excitation sources 40 and 50 at different wavelengths. At least one of the sources emits light with a non-visible dominant wavelength (.lambda.sub.1 or .lambda.sub.2). A selector 65 is adapted to select at least one of the sources 40 and 50. Selector 65 may be a deflector such as a movable or pivotable mirror, for example, as illustrated in FIG. 1; other examples are described below. In the embodiment of FIG. 1, selector 65 is a movable or pivotable mirror deflector. Sources 40 and 50 are disposed in alignment with selector 65, which is controllable to direct a beam 20 from any of the sources into an optical path that may include a beam splitter 70. The selected beam 20 hits a target article 30 which, if authentic, has certain fluorescent material(s) which emit fluorescent light 35 when excited by beam 20. Fluorescent light 35 returns to a detector 80 whose signal is processed and analyzed by a processor, which may be a digital signal processor (DSP) 100 or other conventional embedded processor. Detector 80 may be a photodiode as shown in FIG. 1. The DSP 100 also either controls the selector 65 or receives a signal from a transducer indicating the state of selector 65, or both. Where selector 65 is a movable optical element or controllable deflector as shown in FIG. 1, the condition that is sensed by a transducer is the deflector's orientational state. Beam splitter 70 allows the fluorescent light 35 returning from target article 30 to impinge upon detector 80. Conventional optical elements such as lenses 45 and 55 may be used to focus or collimate light from sources 40 and 50 to form beam 20. Also, conventional optical elements such as lenses 25 and 75 may be used to focus or collimate the beam 35 of fluorescent light. An optical filter 88 may be used to select a portion of the spectrum from the light in fluorescent light beam 35 so that detector 80 is exposed to a selected range of wavelengths. Optical filter 88 may be a narrow optical bandpass filter, passing only a narrow selected portion of the spectrum and blocking wavelengths outside that narrow range. Sources 40 and 50 may be filtered as well (not shown in the drawings).

A controller 90, illustrated as a mirror controller in FIG. 1, controls selector 65. As illustrated, controller 90 may be connected to processor DSP 100 or may be integral with DSP 100. That is, DSP 100 may perform the function of controlling selector 65. In alternative embodiments, selector 65 may be controlled independently of DSP 100, but the orientational state of selector 65 is sensed by a conventional transducer (not shown) and the orientational state information sent to DSP 100 for processing in conjunction with information about the fluorescent light detected by detector 80. DSP 100 has conventional outputs (not shown), such as an alphanumeric display or LED indicators, to indicate various aspects of its operation, including a result of its authentication or lack of authentication of target article 30.

The invention may be configured as a hand-held fluorescence scanner, illustrated in FIGS. 2-4. Multiple sources 40, 50, . . . , 60 can be arranged in an array, which may be linear. The multiple sources 40, 50, . . . , 60 may be UV laser diode sources. Multiple detectors 80, 81, 82, 83, 84, 85, . . . , 86 may be arranged in an array. If an array is used, the array may be arranged to have a correspondence between individual laser sources and photodiodes, each corresponding laser-photodiode pair satisfying a predetermined angular limitation. The scanner 10 may also have a one or more visible light source(s) 250, . . . , 260, used for aiming at indicia to be scanned and/or for optimizing distance from the target (scanned article 30). A hand-held embodiment has a housing 15 and a handle 140, and may have a trigger 150 and/or a battery compartment 160. An interface or indicator portion facing the user may include control buttons and/or indicators 110, 120, and 130, to allow control operations and indicate conditions, such as power-on, a positive result of authentication, and presence/absence of a usable signal, for example.

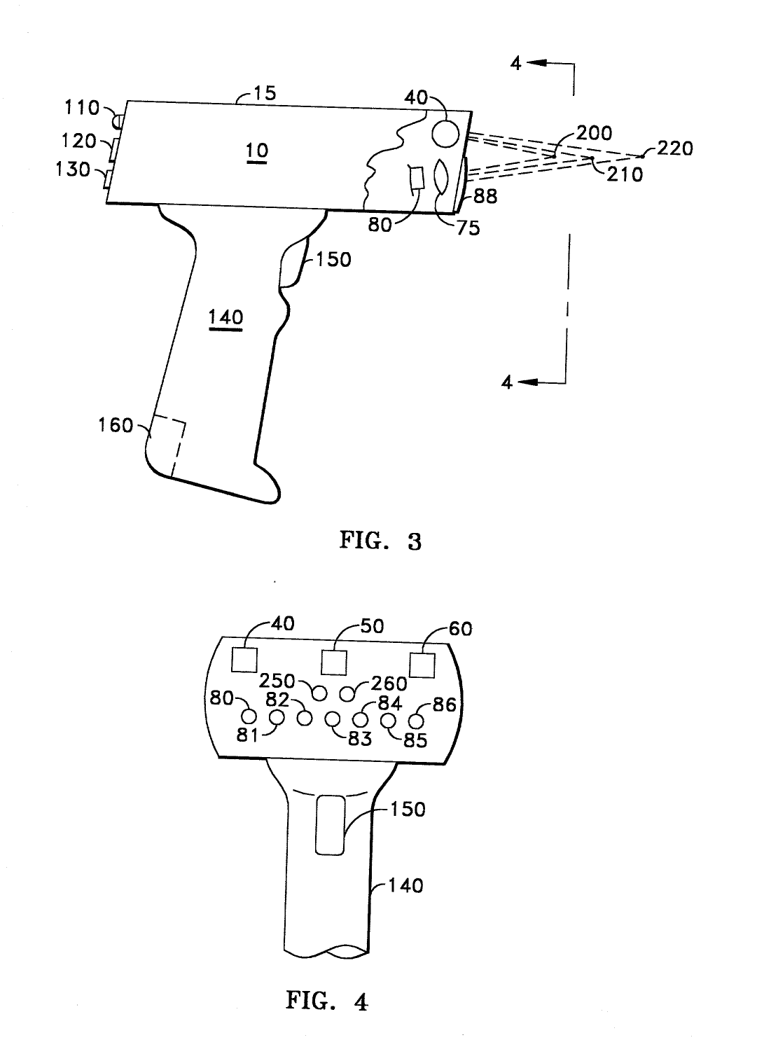

As shown in FIG. 3, various illumination sources 40, 50, . . . , 60, and/or detectors 81, 82, 83, 84, . . . , 85 may have different associated focal lengths, focussing at various focal points 200, 210, 220, etc., which are at various distances from scanner 10. The focal points 200, 210, 220, taken together, define by their range a “depth of focus,” i.e., an effective range of distances from the scanner. Such an arrangement may be used for either the illumination sources or the detectors, or both.

Thus one aspect of the invention is an apparatus 10 for authenticating target articles 30, authentic instances of which are marked with fluorescent indicia. The apparatus comprises a plurality of illumination sources 40, 50, . . . , 60, at least one of which is disposed to selectively illuminate target articles 30 with light 20 outside of the visible spectrum for excitation of the fluorescent indicia, and a selector 65 adapted to select at least one of the plurality of illumination sources 40, 50, . . . , 60. Each source of the plurality of illumination sources 40, 50, . . . , 60 has a dominant wavelength e lambda., but all of these illumination sources do not necessarily have the same dominant wavelength. In particular, at least one of the illumination sources is adapted to emit ultraviolet (UV) light.

The dominant wavelengths of the various sources are advantageously chosen to be distinct, one from another. The fluorescent materials used for tagging authentic articles respond differently to the various source wavelengths used. For example, the fluorescent materials may fluoresce in one visible color with a particular amplitude in response to excitation by a first ultraviolet wavelength and may fluoresce in a second visible color (or with a higher or lower amplitude of the first visible color) in response to excitation by a second ultraviolet wavelength.

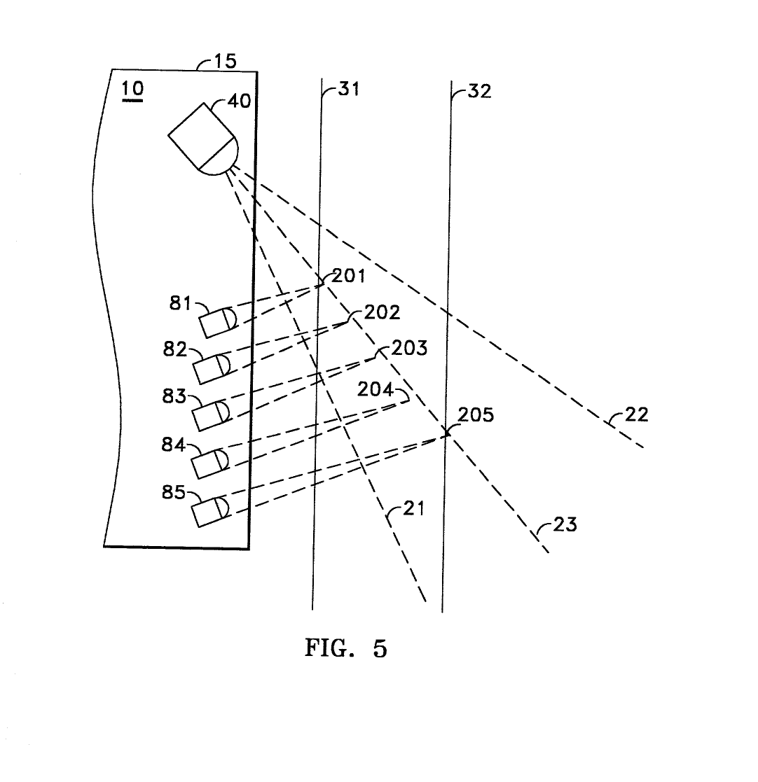

The feature shown in FIG. 3 is illustrated more particularly by embodiment of FIG. 5. FIG. 5 shows a single illumination source 40, which may be a UV laser-diodeor UV LED excitation source, emitting light into a region bounded by angular limits 21 and 22. As shown in FIG. 5, detectors 81, 82, 83, 84, . . . , 85 have various corresponding focal points 201, 202, 203, 204, . . . , 205 respectively. The range in distances from housing 15 defined by focal points 201, 202, 203, 204, . . . , 205 (i.e., by their minimum distance point 201 and maximum distance point 205) is bounded by planes 31 and 32 Thus, that range of distances is an effective depth of focus for the scanner. The array of photodiode detectors 80, 81, 82, 83, 84, . . . , 85 is arranged so that each diode is disposed to satisfy an angular limitation such as the limitation described above, but at different angles. A circuit (e.g., a comparator or a combination of a multiplexer with DSP 100) selects a preferred signal, e.g., the highest amplitude signal or the signal having the strongest signal/noise ratio. Any of the sources 40, . . . , 60 may be modulated at a predetermined frequency. If any of the sources is modulated, the signal selected by DSP 100 may be selected accordingly, e.g., by characterizing the frequency content of detector signals, by synchronous detection, or by appropriate frequency filtering.

It will be understood that the arrangement illustrated in FIG. 5 may be replicated for additional excitation sources 50, 60, etc. like excitation source 40, used with corresponding arrays of detectors like detectors 80, . . . , 85. In such an apparatus, at least two of the illumination sources may have different associated focal lengths.

When any light is reflected from a smooth surface, its angle of reflection equals the angle of incidence, and such an angle is described by the term “specular.” In the present invention, the optical path of the fluorescence radiation returning from the surface being scanned is not at a specular angle with the incident illuminating beam path. A nonspecular-angle arrangement results in improved signal/noise ratios. The optical path of the fluorescence radiation returning from the surface makes an included angle of about 10 to 35 degrees with the incident illuminating beam path. That included angle may be advantageously chosen to be in the range of about 17-26 degrees included angle.

As mentioned above, the illumination sources 40, 50, . . . , 60 may be arranged in an array, e.g., a linear array. Similarly, detectors 80, 81, 82, 83, 84, . . . , 85 may be arranged in an array, e.g., a linear array. In such arrays, the sources and detectors may be interleaved, with each detector disposed to satisfy an angular relationship with a corresponding source such as the relationship described above.

Optionally, a source of visible light 250 may be used to aid a user in aiming the scanner 10 at a desired object to be scanned 30 and/or to aid the user in positioning the scanner at an optimum distance from the object to be scanned 30.

Selector 65 may be a pivotable mirror as shown in FIG. 1 or any functional equivalent known in the art, such as a deformable mirror or simply an electrical switch or relay that selectively actuates various sources by electrically energizing the selected source. One or more electrically controllable holograms such as the addressable electrohologram described in U.S. Pat. No. 5,528,402, to Parker may be used as a selector 65. Selector 65 may be controlled by processor 100, using a suitable conventional actuator (not shown).

According to the type of selector employed, a suitable conventional transducer is used to sense the instantaneous state of selector 65, i.e., to sense which source the selector 65 is choosing when sensed. For a selector 65 of the “deflector” type, such as the pivotable mirror of the embodiment shown in FIG. 1, this state is an orientational state, since it characterizes the orientation of the selector. A suitable transducer has a transducer output responsive to the states of selector 65 to indicate which source is chosen. Processor 100 is adapted for receiving the transducer output for processing in conjunction with the signal(s) from the detector(s).

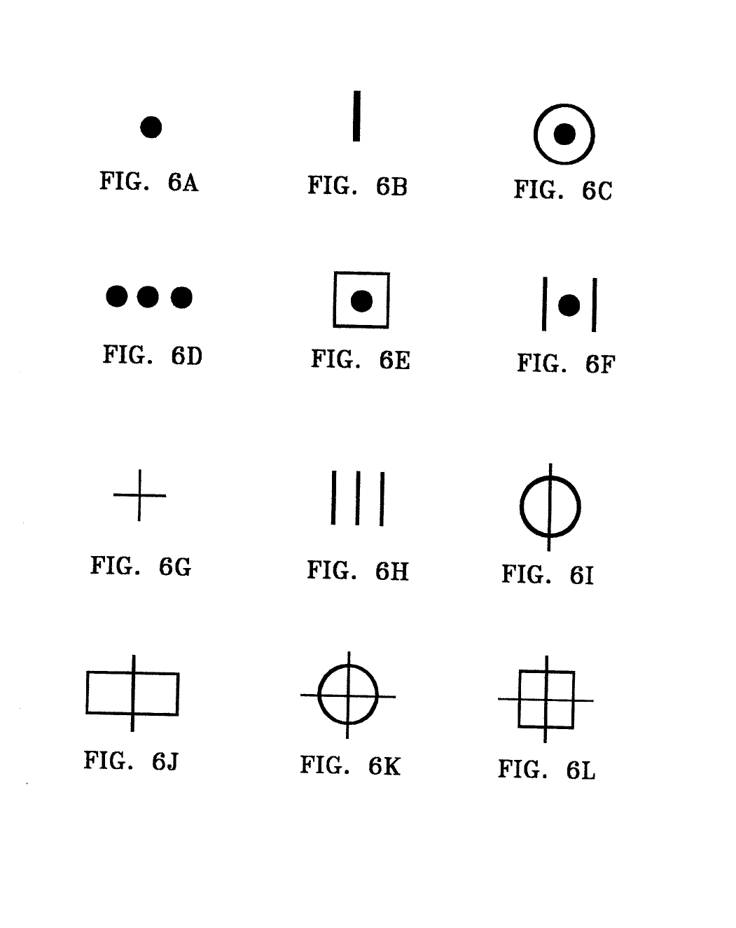

Another aspect of the invention is a scanner apparatus 10 for authenticating articles 30, authentic instances of which are marked with fluorescent indicia, which uses visible indications projected onto the article for aiding the user in aiming the scanner and in positioning the scanner at an optimum distance from the article being scanned. In this aspect, the invention has at least one first illumination source 40, adapted and disposed to illuminate an article with light outside of the visible spectrum for excitation of the fluorescent indicia, at least one second illumination source 250, adapted and disposed to illuminate the article with visible light for indicating a predetermined distance of the scanner apparatus from the article, at least one photodetector 80 responsive to fluorescent radiation emitted by the fluorescent indicia in response to the light outside of the visible spectrum, (the photodetector having a photodetector output), and a processor 100 responsive to the photodetector's output for indicating authentication (or lack of authentication) of the article. Visible light sources 250, . . . , 260 that may be used in this manner are shown in FIGS. 2 and 4. FIGS. 6C-6L illustrate a number of images or patterns that may be projected onto an article by visible-light sources 250, . . . , 260 and used in various ways to indicate that the scanner is properly aimed at the article and/or that it is positioned at the proper predetermined distance from the article. These include a single spot (FIG. 6A), a single line (FIG. 6B), a spot within a circle (bulls eye) (FIG. 6C), a spot centered between two spaced-apart spots (FIG. 6D), a spot centered within a square (FIG. 6E), a spot centered between two spaced-apart parallel lines (FIG. 6F), a pair of crossed lines (FIG. 6G), a line centered between two parallel lines (FIG. 6H), a line bisecting a circle (FIG. 6I), a line bisecting a rectangle (FIG. 6J), a pair of crossed lines whose intersection is centered within a circle (FIG. 6K), a pair of crossed lines whose intersection is centered within a square (FIG. 6L), and various combinations of those. Of course, patterns other than those illustrated may be used for various purposes.

In a simple embodiment, the visible light from a single visible-light source 250 is focused upon the article only when apparatus 10 is disposed at the proper predetermined distance from the articles. For example, a pattern like FIGS. 6A or 6B is projected onto the article and is in sharp focus only at the proper distance. Any of the patterns shown in FIGS. 6A-6L may be projected with a single visible-light source 250 by using a suitable transparency or suitable combination of apertures in a conventional optical projection arrangement (not shown).

In an embodiment only slightly more complex, a second visible-light source 260 projects a second pattern, such as two spots, a circle, two parallel lines, a square or a rectangle. In this embodiment, the visible light from second visible-light sources 260 may be focused upon the article only when apparatus 10 is disposed at the proper predetermined distance from the article being scanned. Furthermore, the second visible-light source 260 may also be adapted to project the second pattern so that it is aligned with the first pattern only when apparatus 10 is disposed at the proper predetermined distance from the article being scanned, thereby producing a readily recognized predetermined combination pattern. Perhaps the simplest such pattern is illustrated in FIG. 6A, both as the spot projected by first visible-light source 250 and as the spot projected by second visible-light source 260, and also as the readily recognized predetermined combination pattern that is projected (merging the two spots into a single spot only when apparatus 10 is disposed at the proper predetermined distance from the article being scanned). Thus, the recognizable combined pattern may be made symmetric. Other such combined patterns are illustrated in FIGS. 6C-6L. For example, a first visible-light source 250 may project a line, and second visible-light source 260 may project a rectangle. The projection geometry is arranged so that the line bisects the rectangle (FIG. 6J) and both the line and rectangle are in focus on target article 30 only when scanner 10 is at the desired predetermined distance from target article 30. Similarly, symmetric combined patterns such as FIGS. 6C-6I and 6K-6L may be formed by various combinations of points or spots, lines, circles, and/or squares. The patterns of FIGS. 6C-6L or other patterns may also be combined in various combinations. For example, first visible-light source 250 may project a pattern like FIG. 6E, and second visible-light source 260 may project a pattern like FIG. 6G.

The invention will be further clarified by considering the following examples, which are intended to be purely exemplary of the use of the invention. In a first example, apparatus made in accordance with the invention has two illumination sources 40 and 50, one adapted to emit light having a dominant wavelength of about 254 nanometers and the other adapted to emit light having a dominant wavelength of about 365 nanometers. Authentic instances of target article 30 are marked with indicia containing certain fluorescent materials which emit fluorescent light 35 when excited by ultraviolet light and which respond differently to the two wavelengths 254 and 365 nanometers. Thus the signals from detector 80 differ when selector 65 is selecting source 40 or source 50 respectively. DSP 100 is programmed in a conventional manner to compare those respective responses of detector 80 with each other and with the background signal (when neither source 40 nor source 50 is illuminating target article 30). An authentication signal is generated by DSP 100 to authenticate target article 30 only when the DSP recognizes a predetermined relationship between the fluorescent responses excited by the two sources having these different wavelengths.

In a second example apparatus, an ultraviolet (UV) emitting LED or solid-state laser source 40 emitting light of wavelength 400 nm is mounted in a hand-held scanner housing 15 as shown schematically in FIG. 5. (Angles in FIG. 5 are not drawn to scale). The UV source 40 may be a gallium nitride LED, like Nichia Model NSHU550E UV LED, emitting light of 370-390 nm wavelength and available from Nichia America of Mountville, Pa. or Nichia Chemical Industries of Tokushima, Japan. The source incident beam of UV light from diode source 40 substantially fills a conical volume, centered on a source incident beam axis 23 and bounded by edge rays 21 and 22. A linear array of photodiode detectors 81, 82, 83, 84, . . . , 85 is disposed such that the axis of each detector makes an included angle with source incident beam axis 23 in the range of about 17-26 degrees. Detectors 81, 82, 83, 84, . . . , 85 have various distinct focal lengths, focussing at points 201, 202, 203, 204, . . . , 205 respectively, at distances from scanner housing 15 that range between a minimum in plane 31 and a maximum in plane 32. With respect to a surface parallel to planes 31 and 32, the axis of each detector makes a non-specular angle with source incident beam axis 23. Thus, UV light from source 40 specularly reflected from an article surface that is parallel to planes 31 or 32 does not intercept any of the detectors.

It may be noted that the roles of source and detector may be reversed in FIG. 5. That is, source 40 may be replaced by a single photodetector and photodetectors 81, 82, . . . , 85 may be replaced by a set of light sources having distinct focal lengths, focussing at corresponding points 201, 202, . . . , 205.

INDUSTRIAL APPLICABILITY

The scanner of the present invention is useful in authenticating articles such as valuable documents, currency, products which may be counterfeited, etc. It may also be used in reading of indicia printed with fluorescent materials, in quality control of articles tagged with fluorescent substances, and for other purposes benefiting from its novel structure and design.

Other embodiments of the invention will be apparent to those skilled in the art from a consideration of this specification or from practice of the invention disclosed herein. For example, UV light from a single source may be split up by fiber optics or other conventional optical elements (e.g., a hologram) to make an effective plurality of excitation sources. Similarly, conventional optical elements may be used to adapt a single detector of fluorescent light to detect fluorescent light from a number of directions satisfying predetermined angular relationships as described hereinabove, e.g., employing multiplexing, thus making an effective plurality of fluorescence detectors. It is intended that the specification and examples be considered as exemplary only, with the true scope and spirit of the invention being defined by the following claims.

Accordingly, the scope of the invention should be determined not by the embodiments illustrated, but by the appended claims and their legal equivalents.

What is claimed is:

1. Apparatus for authenticating articles, authentic instances of which are marked with fluorescent indicia, said apparatus comprising:
a) a plurality of illumination sources, at least one of said illumination sources being disposed to selectively illuminate said articles with light outside of the visible spectrum for excitation of said fluorescent indicia; and
b) a selector adapted to select at least one of said plurality of illumination sources.

2. Apparatus as recited in claim 1, wherein each of said plurality of illumination sources has a dominant wavelength and all of said illumination sources do not have the same dominant wavelength.

3. Apparatus as recited in claim 1, wherein said plurality of illumination sources comprises two sources.

4. Apparatus as recited in claim 1, wherein at least one of said plurality of illumination sources is adapted to emit ultraviolet light.

5. Apparatus as recited in claim 1, wherein at least one of said plurality of illumination sources is adapted to emit light having a dominant wavelength of about 254 nanometers.

6. Apparatus as recited in claim 1, wherein at least one of said plurality of illumination sources is adapted to emit light having a dominant wavelength of about 365 nanometers.

7. Apparatus as recited in claim 1, wherein each of said plurality of illumination sources has an associated focal length and at least two of said plurality of illumination sources have different associated focal lengths.

8. Apparatus as recited in claim 7, wherein said at least two of said plurality of illumination sources are adapted to focus light at different distances from said apparatus.

9. Apparatus as recited in claim 1, wherein each of said plurality of illumination sources is adapted to emit a source beam.

10. Apparatus as recited in claim 1, wherein said selector comprises a deflector adapted and disposed for selecting at least one of said plurality of illumination sources.

11. Apparatus as recited in claim 10, wherein said deflector is disposed and adapted to selectively deflect at least one source beam into a selected optical path direction.

12. Apparatus as recited in claim 10, wherein said deflector comprises a mirror.

13. Apparatus as recited in claim 12, wherein said mirror is pivotable.

14. Apparatus as recited in claim 12, wherein said mirror is deformable.

15. Apparatus as recited in claim 10, wherein said deflector comprises a hologram.

16. Apparatus as recited in claim 15, wherein said hologram is adapted to be electrically controlled.

17. Apparatus as recited in claim 1, further comprising a processor adapted for controlling said selector.

18. Apparatus as recited in claim 17, wherein said processor is a digital signal processor (DSP).

19. Apparatus as recited in claim 1, further comprising a transducer adapted for sensing states of said selector, said transducer having a transducer output responsive to said states of said selector.

20. Apparatus as recited in claim 19, wherein said states of said selector are orientational states.

21. Apparatus as recited in claim 19, further comprising a processor adapted for receiving said transducer output responsive to said states of said selector.

22. Apparatus as recited in claim 21, wherein said processor is a digital signal processor (DSP).

23. Apparatus as recited in claim 21, wherein said processor is further adapted for controlling said selector.

24. Apparatus as in claim 1, further comprising at least one photodetector responsive to fluorescent radiation emitted by said fluorescent indicia and disposed to receive said fluorescent radiation.

25. Apparatus as recited in claim 24, wherein said photodetector is a photodiode.

26. Apparatus as recited in claim 1, further comprising a beam splitter.

27. Apparatus as recited in claim 26, wherein said beam splitter is disposed in at least partial alignment with a selected optical path direction.

28. Apparatus as recited in claim 27, further comprising at least one photodetector disposed in at least partial alignment with said selected optical path direction.

29. Apparatus as recited in claim 27, further comprising at least one deflector disposed in at least partial alignment with said selected optical path direction.

30. Apparatus as recited in claim 1, the combination further comprising a case having a handle, whereby said combination is adapted to a handheld configuration.

31. Apparatus for authenticating articles, authentic instances of which are marked with fluorescent indicia, said apparatus comprising:
a) a plurality of illumination sources, at least one of said illumination sources being disposed to selectively illuminate said articles with light outside of the visible spectrum for excitation of said fluorescent indicia;
b) a deflector disposed and adapted to select radiation from at least one of said plurality of illumination sources and to direct the selected radiation along a first optical path;
c) a photodetector responsive to fluorescent radiation emitted by said fluorescent indicia and disposed in at least partial alignment with a second optical path to receive said fluorescent radiation; and
d) a beam splitter disposed in at least partial alignment with said first optical path and with said second optical path, for selectively directing said selected radiation toward said article and for selectively directing said fluorescent radiation toward said photodetector.

32. Apparatus as recited in claim 31, wherein each of said plurality of illumination sources has a dominant wavelength and all of said illumination sources do not have the same dominant wavelength.

33. Apparatus as recited in claim 31, wherein said plurality of illumination sources comprises two sources.

34. Apparatus as recited in claim 31, wherein at least one of said plurality of illumination sources is adapted to emit ultraviolet light.

35. Apparatus as recited in claim 31, wherein at least one of said plurality of illumination sources is adapted to emit light having a dominant wavelength of about 254 nanometers.

36. Apparatus as recited in claim 31, wherein at least one of said plurality of illumination sources is adapted to emit light having a dominant wavelength of about 365 nanometers.

37. Apparatus as recited in claim 31, further comprising a processor adapted for controlling said deflector.

38. Apparatus as recited in claim 37, wherein said processor is a digital signal processor (DSP).

39. Apparatus as recited in claim 31, further comprising a transducer adapted for sensing orientational states of said deflector, said transducer having a transducer output responsive to said orientational states.

40. Apparatus as recited in claim 39, further comprising a processor adapted for receiving said transducer output responsive to said orientational states of said deflector.

41. Apparatus as recited in claim 40, wherein said processor is a digital signal processor (DSP).

42. Apparatus as recited in claim 40, wherein said processor is further adapted for controlling said deflector.

43. Apparatus as recited in claim 31, the combination further comprising a case having a handle, whereby said combination is adapted to a handheld configuration.

44. Apparatus for authenticating articles, authentic instances of which are marked with fluorescent indicia, said apparatus comprising:
a) at least one illumination source, disposed to illuminate said articles with light outside of the visible spectrum for excitation of said fluorescent indicia, said light being directed along a first optical path intercepting said articles;
b) a plurality of photodetectors responsive to fluorescent radiation emitted by said fluorescent indicia, each of said plurality of photodetectors having an associated output and being disposed in at least partial alignment with an associated optical path to receive said fluorescent radiation from said articles; and
c) an output selector for selecting an output from at least one of said plurality of photodetectors in accordance with at least one predetermined characteristic of said output.

45. Apparatus as in claim 44, wherein said predetermined characteristic of said output is its amplitude.

46. Apparatus as in claim 44, wherein said predetermined characteristic of said output is its signal-to-noise ratio.

47. Apparatus as in claim 44, wherein said predetermined characteristic of said output is its frequency content.

48. Apparatus as recited in claim 44, wherein said output selector is a digital signal processor (DSP) having an input for receiving an output from each of said plurality of photodetectors and having a DSP output responsive to the selected photodetector output.

49. Apparatus as recited in claim 44, wherein each of said plurality of photodetectors has an associated focal distance, whereby said plurality of photodetectors spans a range of focal distances from a minimum focal distance to a maximum focal distance, thereby defining a depth of focus.

50. Apparatus as recited in claim 44, wherein the optical path associated with each of said plurality of photodetectors makes an included angle with said first optical path, said included angle being between about 10 degrees and about 35 degrees.

51. Apparatus as recited in claim 50, wherein said included angle is between about 17 degrees and about 26 degrees.

52. Apparatus as recited in claim 44 wherein the optical path associated with each of said plurality of photodetectors makes a non-specular angle with said first optical path.

53. Apparatus for authenticating articles, authentic instances of which are marked with fluorescent indicia, said apparatus comprising:
a) a first plurality of illumination sources, disposed to selectively illuminate said articles with light outside of the visible spectrum for excitation of said fluorescent indicia, said light outside of the visible spectrum being directed along a first incident optical path associated with each of said first plurality of illumination sources;
b) a second plurality of photodetectors responsive to fluorescent radiation emitted by said fluorescent indicia, each of said plurality of photodetectors having an associated output and being disposed in at least partial alignment with an associated second optical path to receive said fluorescent radiation from said articles; and
c) an output selector for selecting an output from at least one of said plurality of photodetectors in accordance with at least one predetermined characteristic of said output.

54. Apparatus as recited in claim 53, wherein said first plurality of illumination sources is disposed in a first linear array.

55. Apparatus as recited in claim 53, wherein said second plurality of photodetectors is disposed in a second linear array.

56. Apparatus as recited in claim 53, wherein said first plurality of illumination sources is disposed in a first linear array, and said second plurality of photodetectors is disposed in a second linear array.

57. Apparatus as recited in claim 55, wherein said first linear array and said second linear array are parallel.

58. Apparatus as recited in claim 53 wherein said first plurality of illumination sources and said second plurality of photodetectors are interleaved in a single linear array.

59. Apparatus as recited in claim 53 wherein each of said first plurality of illumination sources is associated with one of said second plurality of photodetectors.

60. Apparatus as recited in claim 59, wherein the second optical path associated with each of said plurality of photodetectors makes an included angle with the first incident optical path associated with the associated one of said plurality of illumination sources, said included angle being between about 10 degrees and about 35 degrees.

61. Apparatus as recited in claim 60, wherein said included angle is between about 17 degrees and about 26 degrees.

62. Apparatus for authenticating articles, authentic instances of which are marked with fluorescent indicia, said apparatus comprising:
a) at least one first illumination source, adapted and disposed to illuminate one of said articles with light outside of the visible spectrum for excitation of said fluorescent indicia;
b) at least one second illumination source, adapted and disposed to illuminate one of said articles with visible light for indicating a predetermined distance of said apparatus from one of said articles;
c) at least one photodetector responsive to fluorescent radiation emitted by said fluorescent indicia in response to said light outside of the visible spectrum, said at least one photodetector having a photodetector output; and
d) a processor responsive to said photodetector output for indicating authentication of said one of said articles or lack of authentication thereof.

63. Apparatus as recited in claim 62, wherein said visible light is focused upon said one of said articles only when said apparatus is disposed at said predetermined distance from said one of said articles.

64. Apparatus as recited in claim 62, wherein said at least one second illumination source projects an image upon said one of said articles.

65. Apparatus as recited in claim 64, wherein said image is focused upon said one of said articles only when said apparatus is disposed at said predetermined distance from said one of said articles.

66. Apparatus as recited in claim 64, wherein said image comprises a point.

67. Apparatus as recited in claim 64, wherein said image comprises a line.

68. Apparatus as recited in claim 64, wherein said image comprises a circle.

69. Apparatus as recited in claim 64, wherein said image comprises a circle and a point within said circle.

70. Apparatus as recited in claim 62, further comprising: at least one second source of visible light, said second source of visible light being adapted and disposed to illuminate said one of said articles with visible light for indicating said predetermined distance of said apparatus from one of said articles.

71. Apparatus as recited in claim 70, wherein said second source of visible light is focused upon said one of said articles only when said apparatus is disposed at said predetermined distance from said one of said articles.

72. Apparatus as recited in claim 70, wherein said first and second sources of visible light project distinct images upon said one of said articles when said apparatus is disposed at said predetermined distance from said one of said articles.

73. Apparatus as recited in claim 72, wherein said distinct images projected upon said one of said articles form a predetermined combination pattern only when said apparatus is disposed at said predetermined distance from said one of said articles.

74. Apparatus as recited in claim 73, wherein said predetermined combination pattern is selected from the list consisting of:
a single spot, a single line, a spot within a circle (bulls eye), a spot centered between two spaced-apart spots, a spot centered within a square, a spot centered between two spaced-apart parallel lines, a pair of crossed lines, a line centered between two parallel lines, a line bisecting a circle, a line bisecting a rectangle, a pair of crossed lines whose intersection is centered within a circle, a pair of crossed lines whose intersection is centered within a square, and combinations thereof.
